(19) United States
(12) Patent Application Publication
(10) Pub. No.: US 2025/0304276 A1
(43) Pub. Date: Oct. 2, 2025

(54) HYPERSONIC FLIGHT COOLING SYSTEM UTILIZING RAM AIR FOR TRANSPIRATION COOLING

(71) Applicant: Hamilton Sundstrand Corporation, Charlotte, NC (US)

(72) Inventors: Viktor Kilchyk, Lancaster, NY (US); Lance R. Bartosz, Granby, MA (US)

(21) Appl. No.: 18/621,654

(22) Filed: Mar. 29, 2024

(51) Int. Cl. B64D 41/00

(52) U.S. Cl. CPC B64D 41/007

(57) ABSTRACT

A system for transpiration cooling of an outer surface of an aircraft, the system having: a flow conditioning circuit that has: an upstream end defining a RAM airflow inlet that receives a RAM airflow, and a first injection port near the upstream end, through which a first flow of liquid nitrogen is injected into the flow conditioning circuit; a first turbine, coupled to the flow conditioning circuit, downstream of the first injection port, that receives the RAM airflow, extracts energy from the RAM airflow, and directs the RAM airflow downstream along the flow conditioning circuit; and wherein the flow conditioning circuit directs the RAM airflow downstream from the first turbine to the outer surface of the aircraft.

### BACKGROUND

The embodiments are directed to hypersonic flight cooling systems and more specifically to a hypersonic flight cooling system utilizing RAM air for transpiration cooling.

Transpiration cooling (TC) can significantly reduce boundary layer temperature, for example, by 50-60%, and surface drag on hypersonic vehicles. Fuel can be utilized for transpiration cooling. However, fuel onboard an aircraft that is not utilized for engine consumption results in efficiency losses. Cool air is desirable for transpiration cooling, however the high stagnation temperature of RAM air may prevent its use for transpiration cooling.

### BRIEF DESCRIPTION

A system for transpiration cooling of an outer surface of an aircraft, the system comprising: a flow conditioning circuit that includes: an upstream end defining a RAM airflow inlet that receives a RAM airflow, and a first injection port near the upstream end, through which a first flow of liquid nitrogen is injected into the flow conditioning circuit; a first turbine, coupled to the flow conditioning circuit, downstream of the first injection port, that receives the RAM airflow, extracts energy from the RAM airflow, and directs the RAM airflow downstream along the flow conditioning circuit; and wherein the flow conditioning circuit directs the RAM airflow downstream from the first turbine to the outer surface of the aircraft.

In addition to one or more of the above disclosed aspects of the system or as an alternate, the system includes a first heat exchanger, thermally coupled to the flow conditioning circuit downstream of the first turbine, that cools the RAM airflow, wherein the flow conditioning circuit directs the RAM airflow downstream from the first turbine to the outer surface of the aircraft.

In addition to one or more of the above disclosed aspects of the system or as an alternate, the system includes a second heat exchanger, thermally coupled to a fuel flow of the aircraft and to the first heat exchanger, wherein the first heat exchanger receives the RAM airflow from the first turbine, cools the RAM airflow by transferring energy to the fuel flow, and directs the RAM airflow downstream along the flow conditioning circuit.

In addition to one or more of the above disclosed aspects of the system or as an alternate, the first turbine is an impulse turbine.

In addition to one or more of the above disclosed aspects of the system or as an alternate, the system includes a working fluid that is thermally coupled to the first and second heat exchangers.

In addition to one or more of the above disclosed aspects of the system or as an alternate, the system includes a fan that motivates the working fluid to move between the first and second heat exchangers.

In addition to one or more of the above disclosed aspects of the system or as an alternate, the system includes an ejector at the first injection port that mixes the RAM airflow with the first flow of liquid nitrogen.

Disclosed is another embodiment of a system for transpiration cooling of an outer surface of an aircraft, the system comprising: a flow conditioning circuit that includes: an upstream end defining a RAM airflow inlet that receives a RAM airflow, and a first injection port near the upstream end, through which a first flow of liquid nitrogen is injected into the flow conditioning circuit; a first turbine, coupled to the flow conditioning circuit, downstream of the first injection port, that receives the RAM airflow, extracts energy from the RAM airflow, and directs the RAM airflow downstream along the flow conditioning circuit; and a first heat exchanger, thermally coupled to the flow conditioning circuit downstream of the first turbine, that cools the RAM airflow; and a second turbine, coupled to the flow conditioning circuit, downstream of the first heat exchanger, that receives the RAM airflow from the first heat exchanger, and extracts energy from the RAM airflow, wherein the flow conditioning circuit directs the RAM airflow downstream from the second heat exchanger to the outer surface of the aircraft.

In addition to one or more of the above disclosed aspects of the another embodiment of system or as an alternate, the another embodiment of the system includes

a second heat exchanger, thermally coupled to a fuel flow of the aircraft and to the first heat exchanger, wherein the first heat exchanger receives the RAM airflow from the first turbine, cools the RAM airflow by transferring energy to the fuel flow, and directs the RAM airflow downstream along the flow conditioning circuit.

In addition to one or more of the above disclosed aspects of the another embodiment of system or as an alternate, the first turbine is an impulse turbine.

In addition to one or more of the above disclosed aspects of the another embodiment of system or as an alternate, the another embodiment of the system includes a working fluid that is thermally coupled to the first and second heat exchangers.

In addition to one or more of the above disclosed aspects of the another embodiment of system or as an alternate, the another embodiment of the system includes a fan that motivates the working fluid to move between the first and second heat exchangers.

In addition to one or more of the above disclosed aspects of the another embodiment of system or as an alternate, the another embodiment of the system includes an ejector at the first injection port that mixes the RAM airflow with the first flow of liquid nitrogen.

In addition to one or more of the above disclosed aspects of the another embodiment of system or as an alternate, the second turbine generates electricity via a generator.

In addition to one or more of the above disclosed aspects of the another embodiment of system or as an alternate, the second turbine drives a vapor compression system.

In addition to one or more of the above disclosed aspects of the another embodiment of system or as an alternate, the second turbine drives an air cycle machine.

### BRIEF DESCRIPTION OF THE DRAWINGS

The following descriptions should not be considered limiting in any way. With reference to the accompanying drawings, like elements are numbered alike:

FIG. 1 shows a supersonic aircraft that may include a system for conditioning RAM airflow captured from a surface of the supersonic aircraft according to one or more embodiments;

FIG. 2A shows a system for conditioning RAM airflow captured from the surface of the supersonic aircraft, where the system includes a nitrogen injector, a turbine and a heat exchanger loop for conditioning the RAM airflow for transpiration cooling;

FIG. 2B shows another embodiment of the system for conditioning RAM airflow captured from the surface of the supersonic aircraft, where the system includes a nitrogen injector, a plurality of turbines and a heat exchanger loop for conditioning the RAM airflow for transpiration cooling; and

FIG. 2C shows another embodiment of the system for conditioning RAM airflow captured from the surface of the supersonic aircraft, where the system includes a nitrogen injector and a turbine for conditioning the RAM airflow for transpiration cooling.

### DETAILED DESCRIPTION

A detailed description of one or more embodiments of the disclosed apparatus are presented herein by way of exemplification and not limitation with reference to the Figures.

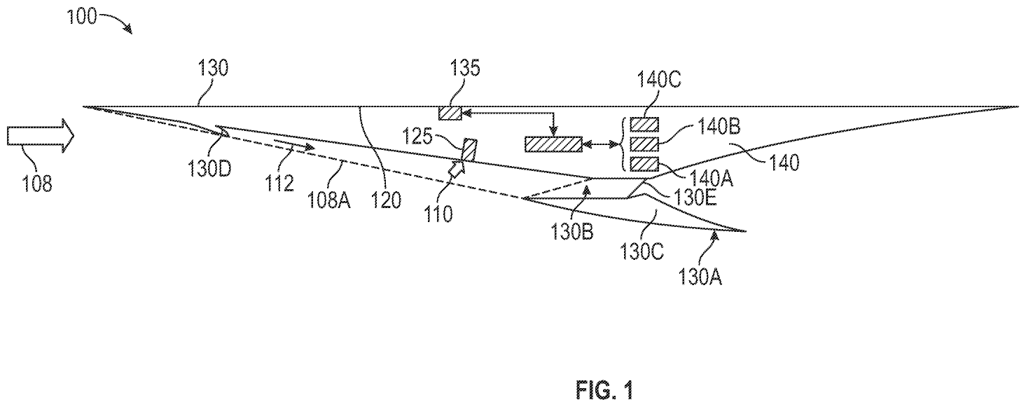

Turning to FIG. 1, a supersonic aircraft 130 is shown. The aircraft 130 has an engine 130A including a combustor 130B within a cowl 130C that receives an airflow 108 and fuel 112 from an injector 130D, which is atomized from a shockwave 108A, to produce a detonation wave 130E. The aircraft 130 is shown as a scramjet with an external injector (external relative to the cowl 130C) but this is not intended to limit the application of the embodiments. The aircraft 130 has internal components 140 such as air cycle machine (ACM) 140A, a vapor compression system (VCS) 140B or other internal system 140C, each shown schematically. The aircraft 130 may have a system 100 for conditioning RAM airflow 110 captured from a surface 120 of the aircraft 130. For example, the RAM airflow 110 may be captured via airflow inlet (e.g., a port) 125, on the surface 120 of the aircraft 130. The system 100 may cool the RAM airflow 110 and deliver it to the surface 135 of the aircraft for transpiration cooling.

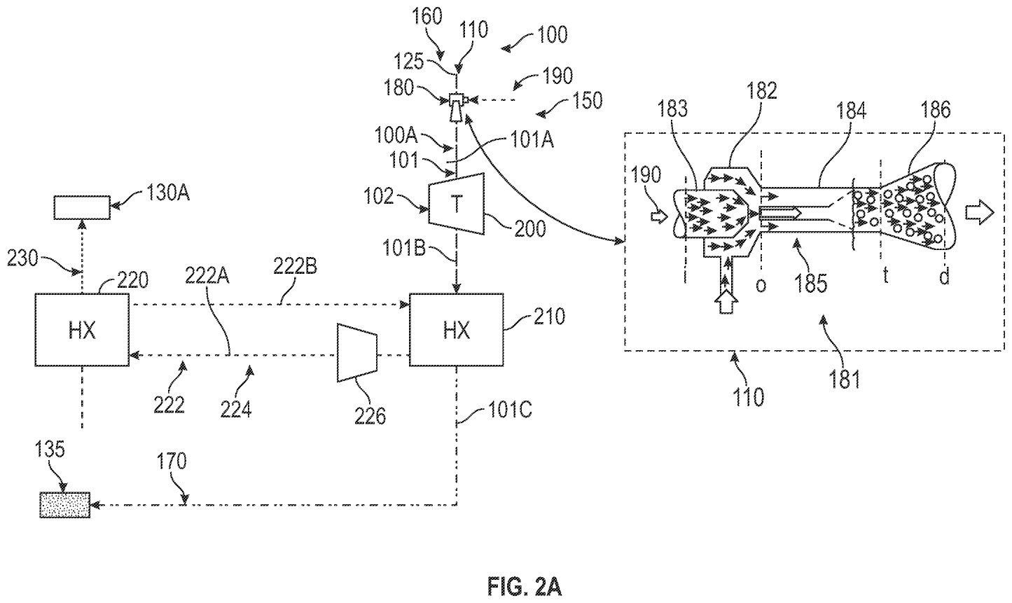

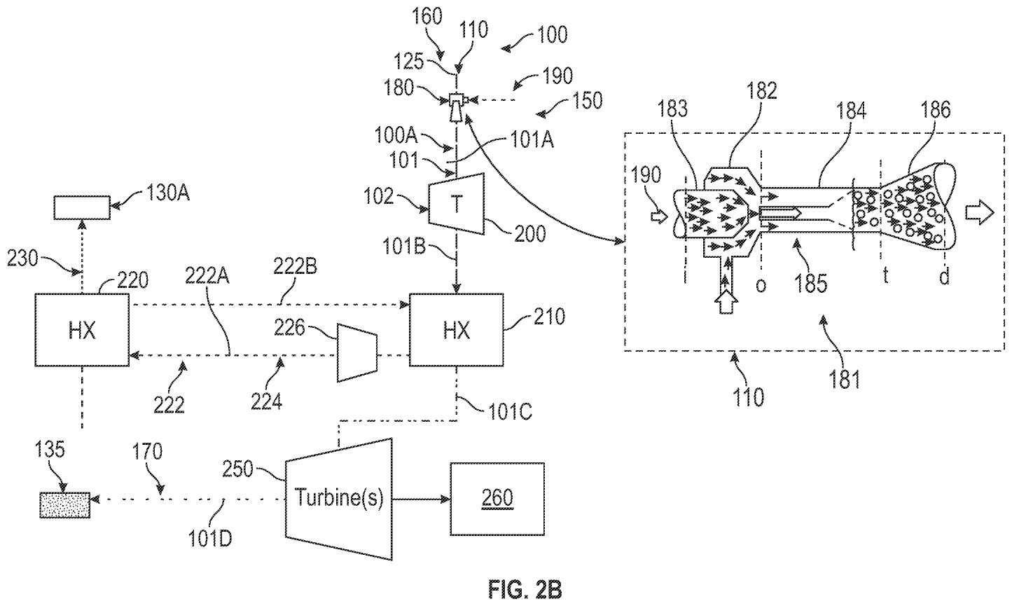

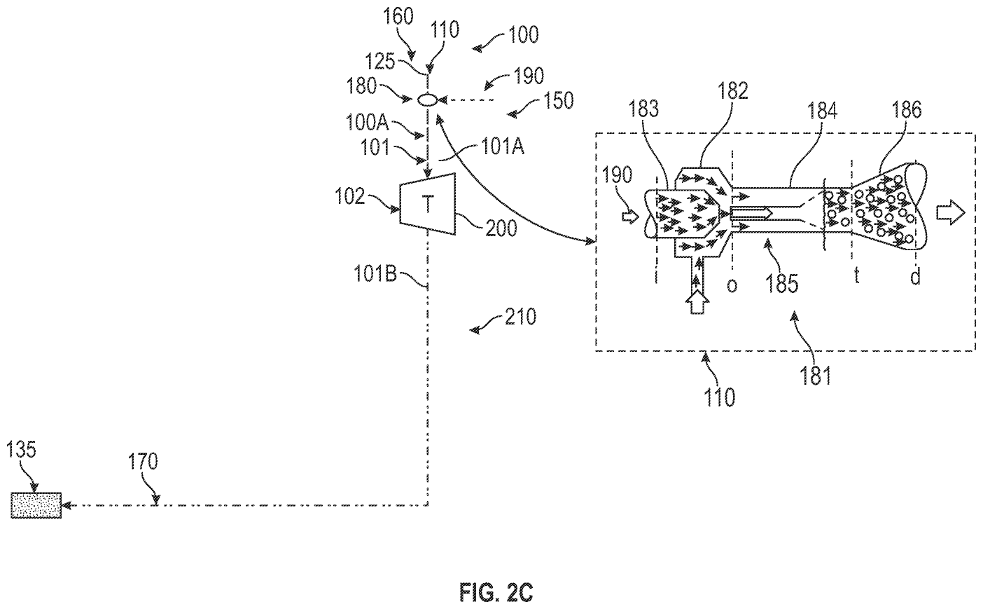

Turning to FIG. 2A, an embodiment of the system 100 includes a flow conditioning circuit 150 defined by circuit conduits 101 and circuit components 102 fluidly coupled to each other via the conduits 101. The circuit 150 includes an upstream end 160 and a downstream end 170. The upstream end 160 has a first conduit 101A that defines the airflow inlet port 125. The RAM airflow 110 is captured at the upstream end 160. A first injection port 180 is near the upstream end 160 along the first conduit 101A, through which a first flow of liquid nitrogen 190 is injected into the circuit 150.

The injection port 180 may include an ejector 181 (or thermo-compressor) having a suction chamber 182 that receives the RAM airflow 110 and a nozzle 183 that injects the nitrogen 190 into the suction chamber 182. A mixing throat 184 is downstream of the suction chamber 182 which defines a mixing zone 185 where the RAM airflow 110 and liquid nitrogen 190 mix. The mixture leaves the ejector 181 via a diffuser 186 and continues along the circuit 150. This component is located in front of the turbine (discussed next) to cool incoming RAM air with N2 and to increase pressure on the turbine inlet.

A first turbine 200 is coupled to the circuit 150, downstream of the first injection port 180, e.g., at a downstream end of the first conduit 101A. The first turbine 200 may be an impulse turbine. An impulse turbine due to its design does not require blade cooling. The first turbine 200 receives the RAM airflow 110, extracts energy from the RAM airflow 110, and directs the RAM airflow 110 downstream along the circuit 150. Using the impulse turbine, the liquid nitrogen injection, or their combination, lowers the reaction turbine inlet temperature to manageable levels.

A first heat exchanger 210 is thermally coupled to the circuit 150, downstream of the first turbine 200, e.g., with a second conduit 101B connecting these components 102. A second heat exchanger 220 is thermally coupled to a fuel flow 230 of the aircraft 130 and to the first heat exchanger 210. The fuel flow 230 may be directed to an engine 130A of the aircraft 130. The first and second heat exchangers 210, 220 are connected via a loop 222 having a working fluid 224 flowing in the loop 222, via loop conduits 222A, 222B. A fluid motivator 226 coupled to the loop 222 motivates the working fluid 224 to flow within the loop 222. The fluid motivator 226 may be a fan, pump, etc. The first heat exchanger 210 receives the RAM airflow 110 from the first turbine 200, cools the RAM airflow 110 by transferring energy to the fuel flow 230, and directs the RAM airflow 110 downstream along the circuit 150.

The RAM airflow 110 at the airflow inlet port 125 has a high temperature and pressure. For example, during supersonic flight, the stagnation temperature of the RAM airflow 110 may approach 2400° K. Injecting the RAM airflow 110 with liquid nitrogen at the first injection port 180 may reduce the temperature and speed of the RAM airflow 110 while increasing its pressure. The first turbine 200 may further cool, expand and reduce pressure and temperature of the RAM airflow 110. Further cooling of the RAM airflow 110 occurs in the first heat exchanger 210. The pre-cooling of the RAM airflow 110, i.e., before entering the first heat exchanger 210, will prevent overheating the working fluid 224 and coking the fuel flow 230. The fuel flow 230 may increase by, e.g., 200K, e.g., starting around 300K and ending around 500K, through the second heat exchanger 220 and the RAM airflow 110 may decrease by the same temperature differential. The embodiment may include a three-way heat exchanger, where an intermediate layer controls heat flux between air and fuel.

Upon exiting the first heat exchanger 210, the RAM airflow 110 is directed downstream along the circuit 150, e.g. via a third conduit 101C, toward the aircraft outer surface 135. This enables transpiration cooling of the outer surface 135. As a result, a boundary layer temperature along the outer surface 135 may be reduced by up to 50% or more.

Turning to FIG. 2B, another embodiment of the system 100 includes a flow conditioning circuit 150 defined by circuit conduits 101 and circuit components 102 fluidly coupled to each other via the conduits 101. The circuit 150 includes an upstream end 160 and a downstream end 170. The upstream end 160 has a first conduit 101A that defines the airflow inlet port 125. The RAM airflow 110 is captured at the upstream end 160. A first injection port 180 is near the upstream end 160 along the first conduit 101A, through which a first flow of liquid nitrogen 190 is injected into the circuit 150.

The injection port 180 may include an ejector 181 (or thermo-compressor) having a suction chamber 182 that receives the RAM airflow 110 and a nozzle 183 that injects the nitrogen 190 into the suction chamber 182. A mixing throat 184 is downstream of the suction chamber 182 which defines a mixing zone 185 where the RAM airflow 110 and liquid nitrogen 190 mix. The mixture leaves the ejector 181 via a diffuser 186 and continues along the circuit 150. This component is located in front of the turbine (discussed next) to cool incoming RAM air with N2 and to increase pressure on the turbine inlet.

A first turbine 200 is coupled to the circuit 150, downstream of the first injection port 180, e.g., at a downstream end of the first conduit 101A. The first turbine 200 may be an impulse turbine. An impulse turbine due to its design does not require blade cooling. The first turbine 200 receives the RAM airflow 110, extracts energy from the RAM airflow 110, and directs the RAM airflow 110 downstream along the circuit 150. Using the impulse turbine, the liquid nitrogen injection, or their combination, lowers the reaction turbine inlet temperature to manageable levels.

A first heat exchanger 210 is thermally coupled to the circuit 150, downstream of the first turbine 200, e.g., with a second conduit 101B connecting these components 102. A second heat exchanger 220 is thermally coupled to a fuel flow 230 of the aircraft 130 and to the first heat exchanger 210. The fuel flow 230 may be directed to an engine 130A of the aircraft 130. The first and second heat exchangers 210, 220 are connected via a loop 222 having a working fluid 224 flowing in the loop 222, via loop conduits 222A, 222B. A fluid motivator 226 coupled to the loop 222 motivates the working fluid 224 to flow within the loop 222. The fluid motivator 226 may be a fan, pump, etc. The first heat exchanger 210 receives the RAM airflow 110 from the first turbine 200, cools the RAM airflow 110 by transferring energy to the fuel flow 230, and directs the RAM airflow 110 downstream along the circuit 150.

The RAM airflow 110 at the airflow inlet port 125 has a high temperature and pressure. For example, during supersonic flight, the stagnation temperature of the RAM airflow 110 may approach 2400° K. Injecting the RAM airflow 110 with liquid nitrogen at the first injection port 180 may reduce the temperature and speed of the RAM airflow 110 while increasing its pressure. The first turbine 200 may further cool, expand and reduce pressure and temperature of the RAM airflow 110. Further cooling of the RAM airflow 110 occurs in the first heat exchanger 210. The pre-cooling of the RAM airflow 110, i.e., before entering the first heat exchanger 210, will prevent overheating the working fluid 224 and coking the fuel flow 230. The fuel flow 230 may increase by, e.g., 200K, e.g., starting around 300K and ending around 500K, through the second heat exchanger 220 and the RAM airflow 110 may decrease by the same temperature differential. The embodiment may include a three-way heat exchanger, where an intermediate layer controls heat flux between air and fuel.

Upon exiting the first heat exchanger 210, the RAM airflow 110 is directed downstream along the circuit 150 to a second turbine 250, e.g. via a third conduit 101C. The second turbine 250 receives the RAM airflow 110 from the first heat exchanger 210, extracts energy from the RAM airflow 110, and directs the RAM airflow 110 downstream along the circuit 150, along a fourth conduit 101D. Extracted energy may be utilized to power an aircraft component 260, which may be a generator as one nonlimiting example to generate electricity. Alternatively the aircraft component 260 may be a mechanically driven component of the aircraft 130, such as air cycle machine (ACM) 140A, a vapor compression system (VCS) 140B or other internal system 140C (generally 140).

The circuit 150 directs the RAM airflow 110 from the second turbine 250 toward the aircraft outer surface 135. This enables transpiration cooling of the outer surface 135. As a result, a boundary layer temperature along the outer surface 135 may be reduced by up to 50% or more.

Turning to FIG. 2C, another embodiment of the system 100 includes a flow conditioning circuit 150 defined by circuit conduits 101 and circuit components 102 fluidly coupled to each other via the conduits 101. The circuit 150 includes an upstream end 160 and a downstream end 170. The upstream end 160 has a first conduit 101A that defines the airflow inlet port 125. The RAM airflow 110 is captured at the upstream end 160. A first injection port 180 is near the upstream end 160 along the first conduit 101A, through which a first flow of liquid nitrogen 190 is injected into the circuit 150.

The injection port 180 may include an ejector 181 (or thermo-compressor) having a suction chamber 182 that receives the RAM airflow 110 and a nozzle 183 that injects the nitrogen 190 into the suction chamber 182. A mixing throat 184 is downstream of the suction chamber 182 which defines a mixing zone 185 where the RAM airflow 110 and liquid nitrogen 190 mix. The mixture leaves the ejector 181 via a diffuser 186 and continues along the circuit 150. This component is located in front of the turbine (discussed next) to cool incoming RAM air with N2 and to increase pressure on the turbine inlet.

A first turbine 200 is coupled to the circuit 150, downstream of the first injection port 180, e.g., at a downstream end of the first conduit 101A. The first turbine 200 may be an impulse turbine. Alternatively, the first turbine 200 may be a reaction, boundary layer or hybrid turbine type. An impulse turbine due to its design does not require blade cooling. The first turbine 200 receives the RAM airflow 110, extracts energy from the RAM airflow 110, and directs the RAM airflow 110 downstream along the circuit 150. Using the impulse turbine 200, the liquid nitrogen injection, or their combination, lowers the reaction turbine inlet temperature to manageable levels. The embodiment may include a three-way heat exchanger, where an intermediate layer controls heat flux between air and fuel.

Upon exiting the first turbine 200, the RAM airflow 110 is directed downstream along the circuit 150 via a second conduit 101B toward the aircraft outer surface 135. This enables transpiration cooling of the outer surface 135. As a result, a boundary layer temperature along the outer surface 135 may be reduced by up to 50% or more.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for transpiration cooling of an outer surface of an aircraft, the system comprising:
a flow conditioning circuit that includes:
an upstream end defining a RAM airflow inlet that receives a RAM airflow, and a first injection port near the upstream end, through which a first flow of liquid nitrogen is injected into the flow conditioning circuit;
a first turbine, coupled to the flow conditioning circuit, downstream of the first injection port, that receives the RAM airflow, extracts energy from the RAM airflow, and directs the RAM airflow downstream along the flow conditioning circuit; and
wherein the flow conditioning circuit directs the RAM airflow downstream from the first turbine to the outer surface of the aircraft.

2. The system of claim 1, further comprising
a first heat exchanger, thermally coupled to the flow conditioning circuit downstream of the first turbine, that cools the RAM airflow,
wherein the flow conditioning circuit directs the RAM airflow downstream from the first turbine to the outer surface of the aircraft.

3. The system of claim 2, further comprising
a second heat exchanger, thermally coupled to a fuel flow of the aircraft and to the first heat exchanger,
wherein the first heat exchanger receives the RAM airflow from the first turbine, cools the RAM airflow by transferring energy to the fuel flow, and directs the RAM airflow downstream along the flow conditioning circuit.

4. The system of claim 2, wherein the first turbine is an impulse turbine.

5. The system of claim 3, including a working fluid that is thermally coupled to the first and second heat exchangers.

6. The system of claim 5, including a fan that motivates the working fluid to move between the first and second heat exchangers.

7. The system of claim 2, further comprising an ejector at the first injection port that mixes the RAM airflow with the first flow of liquid nitrogen.

8. A system for transpiration cooling of an outer surface of an aircraft, the system comprising:
a flow conditioning circuit that includes:
an upstream end defining a RAM airflow inlet that receives a RAM airflow, and a first injection port near the upstream end, through which a first flow of liquid nitrogen is injected into the flow conditioning circuit;
a first turbine, coupled to the flow conditioning circuit, downstream of the first injection port, that receives the RAM airflow, extracts energy from the RAM airflow, and directs the RAM airflow downstream along the flow conditioning circuit; and
a first heat exchanger, thermally coupled to the flow conditioning circuit downstream of the first turbine, that cools the RAM airflow; and
a second turbine, coupled to the flow conditioning circuit, downstream of the first heat exchanger, that receives the RAM airflow from the first heat exchanger, and extracts energy from the RAM airflow,
wherein the flow conditioning circuit directs the RAM airflow downstream from the second heat exchanger to the outer surface of the aircraft.

9. The system of claim 8, further comprising
a second heat exchanger, thermally coupled to a fuel flow of the aircraft and to the first heat exchanger,
wherein the first heat exchanger receives the RAM airflow from the first turbine, cools the RAM airflow by transferring energy to the fuel flow, and directs the RAM airflow downstream along the flow conditioning circuit.

10. The system of claim 8, wherein the first turbine is an impulse turbine.

11. The system of claim 9, including a working fluid that is thermally coupled to the first and second heat exchangers.

12. The system of claim 11, including a fan that motivates the working fluid to move between the first and second heat exchangers.

13. The system of claim 8, further comprising an ejector at the first injection port that mixes the RAM airflow with the first flow of liquid nitrogen.

14. The system of claim 8, wherein the second turbine generates electricity via a generator.

15. The system of claim 8, wherein the second turbine drives a vapor compression system.

16. The system of claim 8, wherein the second turbine drives an air cycle machine.
